(19) United States
(12) Patent Application Publication
(10) Pub. No.: US 2025/0129937 A1
(43) Pub. Date: Apr. 24, 2025

(54) Recuperative Burner

(71) Applicant: WS - Wärmeprozesstechnik GmbH, Renningen (DE)

(72) Inventors: Joachim A. Wünning, Leonberg (DE); Joachim G. Wünning, Leonberg (DE)

(73) Assignee: WS - Wärmeprozesstechnik GmbH, Renningen (DE)

(21) Appl. No.: 18/722,393

(22) PCT Filed: Dec. 9, 2022
(86) PCT No.: PCT/EP2022/085230

§ 371 Date: Jun. 20, 2024

(30) Foreign Application Priority Data
Dec. 20, 2021 (EP) 21215985.9

(51) Int. Cl. F23L 15/04; C01B 3/04; F23C 7/00; F28D 7/00; F28F 9/00

(52) U.S. Cl. CPC F23L 15/04; C01B 3/047; F23C 7/008; F28D 7/0066; F28F 9/005

(57) ABSTRACT

The invention relates to a recuperator (3) for a recuperative burner (1), said recuperator comprising a hot side and a cold side; a housing (31) which is closed in the circumferential direction and surrounds an exhaust gas channel (32) through which a flow can pass in the longitudinal direction; and a plurality of heat exchanger tubes located in the exhaust gas channel, wherein a first connection chamber (301) having a first supply connection (37) for combustion air and a second connection chamber (302) having a second supply connection (38) for a fuel gas are provided on the cold side of the exhaust gas channel (32), wherein the exhaust gas channel (32) is divided at least into a first segment (321) fluidically connected to the first connection chamber (301) and a second segment (322) fluidically connected to the second connection chamber (302), in each of which segments some of the heat exchanger tubes (33) are located and through which the exhaust gas can flow in parallel, the division of the exhaust gas channel being such that the ratio of the heat capacity flow of the cold side to the heat capacity flow of the hot side is between 0.9 and 1.1. The invention also relates to a recuperative burner (1).

### TECHNICAL FIELD AND PRIOR ART

The invention relates to a recuperator for a recuperative burner and to a recuperative burner.

In a recuperative burner, a supplied combustion air is preheated by means of a discharged exhaust gas. Recuperative burners are known, for example, from EP 1 995 516 A1. Among other things, they are used to generate process heat, for example for direct or indirect heating of industrial furnaces. In the case of direct heating, combustion takes place in a furnace chamber. In the case of indirect heating, combustion takes place in a chamber separated from the furnace chamber, for example inside a radiant tube that projects into the furnace chamber but is sealed off from it, wherein the chamber or the steel tube is heated by the combustion and emits heat radiation.

For fossil fuel gases with calorific values above around 5 kWh/m3, such as natural gas or propane, state-of-the-art recuperative burners achieve a relative air preheating of over 80% in relation to an inlet temperature of the exhaust gas. This increases the firing efficiency to over 85%.

In the future, for generating process heat, fossil fuel gases will increasingly be replaced by lean gases. Lean gases are gases and gas mixtures with a lower calorific value, for example gas mixtures in which high-energy alkanes are contaminated with non-flammable components such as nitrogen, CO2 or water vapour. Lean gases include residual gases in the chemical and steel industries, residual gases from fuel cells, gas from wood gasifiers, flushing gases from pressure change systems and landfill waste gases. Hydrogen and ammonia, which also have a significantly lower calorific value compared to natural gas or propane gas, are also referred to as lean gases in connection with the application.

For combustion gases with a lower calorific value, the heat capacity flow of the outflowing exhaust gas is significantly greater than that of the supplied combustion air, so that the exhaust gas is cooled less despite high air preheating.

### OBJECTIVE AND SOLUTION

It is the objective of the invention to provide a recuperator for a recuperative burner and a recuperative burner which, even when using lean gases, make possible a firing efficiency of at least 80% by lowering the exhaust gas temperature to 300° C. or less.

These objectives are achieved by the recuperator with the features of claim 1 and the recuperative burner with the features of claim 12.

According to a first aspect, a recuperator for a recuperative burner having a housing which is closed in the circumferential direction and which surrounds an exhaust gas duct through which an exhaust gas can flow in the longitudinal direction, and having a plurality of heat exchanger tubes arranged in the exhaust gas duct, is provided, wherein a first connection chamber with a first supply connection for combustion air and a second connection chamber with a second supply connection for a combustion gas are provided on the cold side of the exhaust gas duct, wherein the exhaust gas duct is subdivided at least into a first segment fluidically connected to the first connection chamber and a second segment fluidically connected to the second connection chamber, in each of which a part of the heat exchanger tubes is arranged and through which the exhaust gas can flow in parallel, such that a ratio of the heat capacity flow of the cold side to the heat capacity flow of the hot side is between 0.9 and 1.1.

In the context of the application, the terms “a” and “an” are only used as indefinite articles and should not be interpreted as numerals. The terms “first” and “second” are only used to distinguish elements and do not indicate the order of the elements.

The exhaust gas flows consistently through the two or more segments. This ensures that both the combustion air and the combustion gas are heated by means of the exhaust gas in the segments of the recuperator. By supplying combustion air and combustion gas at the cold side, the heat capacity flow of the cold side is increased so that the heat capacity flow of the cold side is almost equal to the heat capacity flow of the hot side. Heat capacity flow is the product of mass flow and heat capacity. Due to the at least approximately equal heat capacity flows, the exhaust gas can be cooled to approximately the same extent as the combustion air and the combustion gas are heated. If, for example, with an exhaust gas inlet temperature of 1000° C., the combustion air and the combustion gas is preheated to 800° C., the exhaust gas is cooled to the same extent, i.e. below 250° C.

In one embodiment, the exhaust gas duct is subdivided into three segments, wherein three gas streams, in particular a primary air, a secondary air and the combustion gas, can flow through the heat exchanger tubes arranged in the segments in parallel. Splitting the combustion air into primary air and secondary air is used for staged combustion, which can reduce the formation of thermal NOx. In an advantageous embodiment, separate connection chambers are provided for the three segments, each with its own supply connection.

In one embodiment, the three segments each have the same flow cross-sections. However, other subdivisions are also conceivable. The subdivision into segments can be carried out by the skilled person depending on the specific application.

In one embodiment, the division into segments is achieved exclusively by assigning the heat exchanger tubes to dedicated connection chambers, wherein the exhaust gas flows freely between segments.

In another embodiment, filling elements are provided between the segments in order to reduce a flow cross-section, in particular a gap width between heat exchanger tubes designed as flat tubes. In one embodiment, the filling elements are perforated plates made of a heat-resistant material, in particular steel. In other embodiments, corrugated sheet metal inserts are provided as filling elements.

In one embodiment, the heat exchanger tubes are accommodated on the cold side and/or on the hot side in a connection plate arranged at a distance from the housing, with an outlet opening or an inlet opening for the exhaust gas duct being formed between the connection plate and the housing. The exhaust gas can flow from all sides into the exhaust gas duct. In an advantageous embodiment, a collecting chamber surrounding the ends of the heat exchanger tubes with an exhaust gas connection for the exhaust gas is provided at the cold side.

In one embodiment, a catalyst, in particular a catalyst for ammonia splitting, is arranged in the heat exchanger tubes of the second segment. Due to a low flame propagation, direct ignition of ammonia is generally not possible. When the ammonia used as combustion gas is preheated in the heat exchanger tubes, ammonia partially splits so that hydrogen is formed, which promotes ignition. In one embodiment, this effect is enhanced by providing in part or all of the heat exchanger tubes of the second segment, i.e. in heat exchanger tubes in which the combustion gas is heated, a catalyst, for example a mesh made of nickel wire.

Alternatively or additionally, in one embodiment, a catalyst, in particular a catalyst for the oxidation of ammonia, is arranged in the exhaust gas duct, in an exhaust gas connection and/or downstream of the exhaust gas connection. With ammonia as a combustion gas, traces of ammonia can remain in the exhaust gas depending on the temperature and dwell time in the heating chamber. In one embodiment, a catalyst is installed downstream of the exhaust gas connection for oxidizing the ammonia residues.

In one embodiment, a central tube for a starting heater is arranged in the housing, with the exhaust duct surrounding the central tube. The heat exchanger tubes are arranged around the central tube. The starting heater is used to start up the recuperative burner, in particular when used with a lean gas whose calorific value is very low, in particular less than 1 kWh/m3. In one embodiment, the starting heater comprises a gas lance for supplying a gas with a higher calorific value and/or an electric heater.

In an advantageous embodiment, the housing has a circular or a polygon-shaped cross-section, wherein the exhaust duct is divided into coaxially arranged, annular segments. The division allows a uniform flow through all segments. On the cold side, coaxially arranged, annular connection chambers to the segments are provided in embodiments.

The heat exchanger tubes are preferably designed as flat tubes, which are in particular arranged in concentric circles. Flat tubes are heat exchanger tubes that have a flattened gap cross-section in a section used for heat transfer. Ends of the flat tubes, with which they are in particular connected to the connecting plates, are round or polygonal in some embodiments. Recuperators with flat tubes are also known as flat tube heat exchangers. In one embodiment, corrugated sheet metal inserts are arranged between the flat tubes to increase the heat exchanger surface and reduce the gap width between the flat tubes.

According to a second aspect, a recuperative burner with a recuperator is provided, wherein the recuperator comprises a housing which is closed in the circumferential direction and surrounds an exhaust gas duct through which exhaust gas can flow in the longitudinal direction, and a plurality of heat exchanger tubes arranged in the exhaust gas duct, wherein the exhaust gas duct is divided into at least two segments for heating the combustion air and the combustion gas.

In one embodiment, the heat exchanger tubes of the first segment and the second segment open on the hot side into a combustion chamber surrounded by a combustion chamber housing. The combustion chamber is also referred to as combustion space and the combustion chamber housing accordingly as combustion space housing.

In one embodiment, a temperature sensor is provided at an inlet of the combustion chamber, wherein further an adjusting device is provided at the first supply connection and/or at the second supply connection, wherein the adjusting device is set up (or the adjusting devices are set up) in order to adjust a quantity of combustion air supplied via the first supply connection in relation to a quantity of combustion gas supplied via the second supply connection as a function of a temperature detected by the temperature sensor at the inlet of the combustion chamber. In particular, the recuperative burner is operated in such a way that, as the temperature of the gas flows supplied to the combustion chamber increases, the amount of combustion air supplied to the combustion chamber is reduced in relation to the amount of combustion gas supplied to the combustion chamber. This makes it possible to avoid an excessive rise in temperature in the combustion chamber.

In one embodiment, the exhaust gas duct is subdivided into three segments, wherein three gas flows, in particular primary air, secondary air and the combustion gas, can flow in parallel through the heat exchanger tubes arranged in the segments, wherein the heat exchanger tubes of the third segment, on the hot side, open into an air guide housing surrounding the combustion chamber housing. In an advantageous embodiment, the third segment surrounds the first segment and the second segment.

The design allows for staged combustion, wherein preheated primary air and preheated combustion gas are supplied to the combustion chamber for a combustion process. A residual gas from this combustion process is burnt with the secondary air preheated in the third segment, preferably in a flameless oxidation process to prevent the formation of nitrogen oxides.

In embodiments of the recuperative burner, the combustion chamber housing and the air guide housing have outlet nozzles to the furnace chamber for this purpose.

### BRIEF DESCRIPTION OF THE DRAWINGS

Further advantages and aspects of the invention are apparent from the claims and from the description of an embodiment of the invention, which is described below with reference to the figures. In which:

FIG. 1 a recuperative burner arranged on a furnace wall with a recuperator in longitudinal section;

FIG. 2 a connection head of the recuperator of FIG. 1 in a sectional view along II-II,

FIG. 3 a bottom view of the recuperative burner of FIG. 1, and

FIG. 4: a sectional view of the recuperator of FIG. 1.

### DETAILED DESCRIPTION OF THE EMBODIMENTS

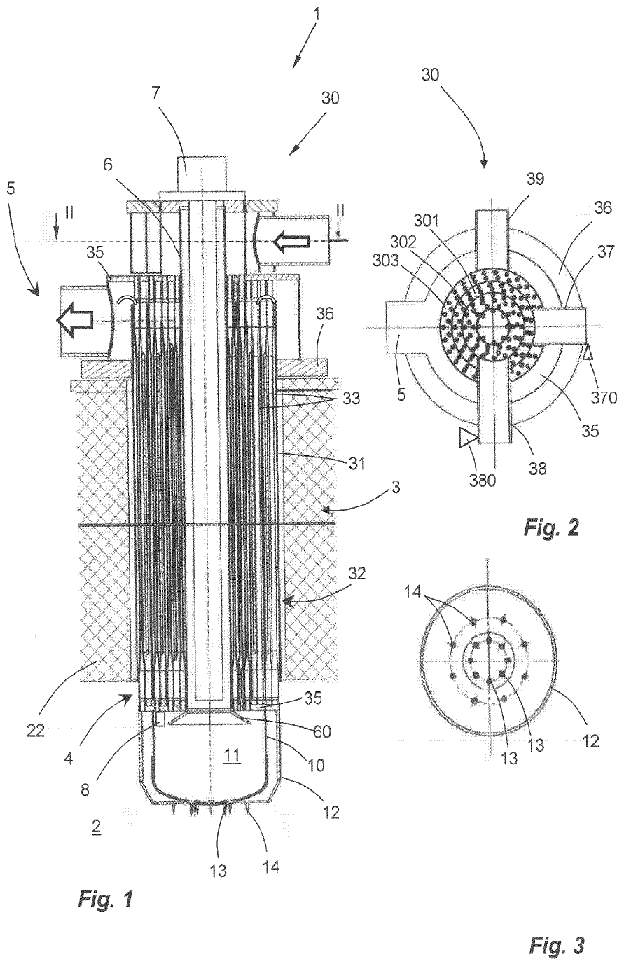

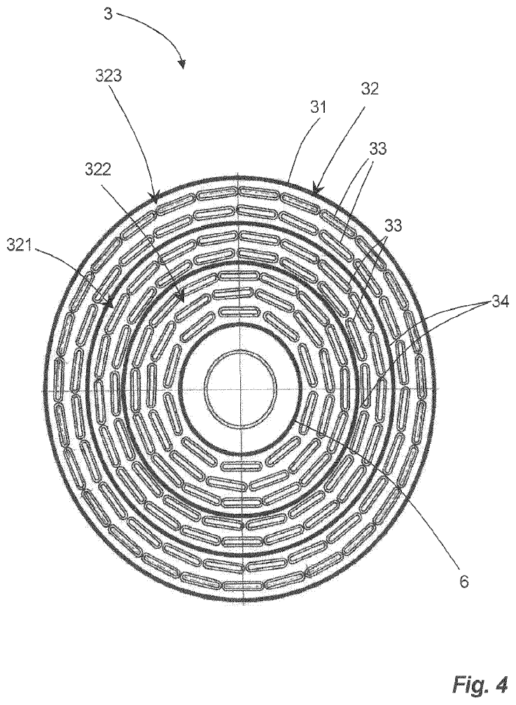

FIGS. 1 to 3 show an embodiment of a recuperative burner 1 comprising a heat exchanger or recuperator 3 for preheating combustion air and fuel. FIG. 4 shows a sectional view of the recuperator 3.

The recuperative burner 1 shown can be operated in particular with so-called lean gases, wherein both a supplied combustion air and a supplied combustion gas are preheated in the recuperator 3 using the exhaust gas energy.

The recuperative burner 1 shown is used, for example, to heat a furnace chamber 2 and is arranged at an opening in a furnace wall in a furnace insulation 22.

As can best be seen in FIG. 4, the recuperator 3 shown is a flat tube heat exchanger with a housing 31 that has a circular cross-section. The housing 31 surrounds an exhaust duct 32 in which flat tubes 33 are accommodated. The flat tubes 33 are arranged along several, in the illustrated embodiment example seven, concentric circles in the housing 31.

The flat tubes 33 are held at both ends in connecting plates 35. The flat tubes 33 are tightly connected to the connecting plates 35, for example soldered to them. The flat tubes 33 are longer than the housing 31 and the connecting plates 35 are offset in each case to the ends of the housing 31, so that an inlet opening 4 and an outlet opening 5 for the exhaust gas are formed between the ends off the housing 31 and the connection plates 35. A flange plate 36 is provided on the cold side of the recuperator 3 for attaching the recuperator 3 to the furnace wall.

In the embodiment example shown, the exhaust duct 32 is subdivided into three segments 321, 322, 323, through which the exhaust gas can flow in parallel. To each segment 321, 322, 333, a part of the flat tubes 33 is allocated.

The recuperator 3 has a connection head 30 located outside the furnace chamber 2, on a cold side of the recuperator 3, for supplying combustion air and gas. A cross-section of the connection head 30 is shown in FIG. 2. As can be seen in FIG. 2, the connection head 30 shown has three separate supply connections 37, 38, 39 for a materially separate supply of three gas streams to the flat tubes 33 of the three segments 321, 322, 323. In the illustrated embodiment, a first supply connection 37 for a primary air supply, a second supply connection 38 for a fuel supply and a third supply connection 39 for a secondary air supply are provided. The supply connections 37, 38, 39 each open into a connection chamber 301, 302, 303. In the illustrated embodiment example, the second supply connection 38 and the third supply connection 39 are offset by 90° to the first supply connection 37 arranged between them. However, other arrangements are also conceivable. The connection chambers 301, 302, 303 each have a circular cross-section and are arranged concentrically to the central axis of the recuperator 3. The first connection chamber 301 is located between the inner second connection chamber 302 and the outer third connection chamber 303. The connection chambers 301, 302, 303 are separated via webs.

In the illustrated embodiment, the segments 321, 322, 323 are each annular in shape and arranged concentric to a central axis of the recuperator 3. A size and/or design of the segments 321, 322, 323 can be suitably selected by the skilled person depending on the specific application.

In the illustrated embodiment, an intermediate first segment 321 and an inner second segment 322 are designed to have the same number of flat tubes 33 and at least approximately the same flow cross-section around the flat tubes 33, so that in use gas flows guided in the flat tubes 33 are heated at least substantially the same amount by the exhaust gas flowing around the flat tubes 33.

Filling elements 34 are provided between the segments 321, 322, 323 in order to minimize the gap width between the flat tubes. The filling elements 34 are preferably selected in such a way that they do not prevent a flow between the segments 321, 322, 323. For example, the filling elements are perforated plates made of heat-resistant steel, which cause turbulence in the exhaust gas flow.

The recuperative burner 1 shown is used for staged combustion.

For staged combustion, on the hot side the recuperative burner 1 has a combustion chamber 11, also referred to as combustion space, primary combustion space, or primary combustion chamber, surrounded by a combustion chamber housing 10, also referred to as combustion space housing 10, as well as an air guide housing 12 surrounding the combustion chamber housing 10.

The combustion chamber housing 10 and the air guide housing 12 each have outlet nozzles 13, 14 to the furnace chamber 2.

In the illustrated embodiment, a schematically depicted temperature sensor 8 is provided at an inlet of the combustion chamber 11. Furthermore, an adjusting device 370, 380 is provided at each of the first supply connection 37 and at the second supply connection, by means of which a quantity of the primary air supplied via the first supply connection 37 or a quantity of the combustion gas supplied via the second supply connection 38 can be adjusted. In other embodiments, an adjusting device 370, 380 is provided at only one of the two supply connections 37, 38.

FIG. 3 shows a bottom view of the recuperative burner 1 with the outlet nozzles 13 provided on the combustion chamber housing 10 and the outlet nozzles 14 provided on the air guide housing 12. In the embodiment shown, the outlet nozzles 13 and 14 are each evenly distributed along a circle concentric to the central axis of the recuperator. The arrangement and number of outlet nozzles 13, 14 is merely schematic.

A primary air heated in the first segment 321 and a fuel heated in the second segment 322 are fed to the combustion chamber 11 for oxidation. A reaction gas discharged from the combustion chamber 11 is fed to the furnace chamber 2 via the outlet nozzles 13 and there completely oxidized, as required with the addition of the secondary air preheated in the third segment.

A tube 6 is provided concentrically to the central axis of the recuperator 3, which ends in the combustion chamber 11. A baffle plate 60 is provided at the end of the tube 6 located in the combustion chamber.

An additional device 7 for starting up the recuperative burner 1 is provided in the pipe 6, for example in the form of a central gas lance, in order to supply fuel with a higher calorific value to the combustion chamber 11. For example, to heat up the furnace chamber 2, fuel with a higher calorific value, e.g. natural gas, is supplied via the additional device 7. A flame is ignited in the combustion chamber 11, the hot exhaust gases of which enter the furnace chamber 2 via the outlet nozzles 13 in order to heat it up. Once a desired temperature has been reached, the recuperative burner 1 can be operated with the lean gas.

After start-up, oxidation processes in the combustion chamber 11 and in the furnace chamber 2 is preferably carried out in such a way that flame formation is suppressed and thus thermal NOx formation is avoided.

An exhaust gas generated during combustion is at least partially fed into the exhaust gas duct 32 and heats both the combustion air and the supplied combustion gas in the segments 321, 322, 333. By heating the combustion air and the combustion gas, the heat capacity flow of the cold side is increased so that the heat capacity flow of the cold side is approximately equal to the heat capacity flow of the hot side.

In the embodiment shown, the adjusting devices 370, 380 can be used to adjust a quantity of primary air supplied via the first supply connection 37 in relation to a quantity of combustion gas supplied via the second supply connection 38 as a function of a temperature detected by the temperature sensor 8 at the inlet of the combustion chamber 11. The recuperative burner can be operated in such a way that, as the gas flows supplied to the combustion chamber 11 become increasingly preheated, the amount of primary air supplied is reduced in relation to the amount of combustion gas supplied. This allows avoiding an excessive rise in temperature in the combustion chamber 11.

Simultaneous heating of the combustion air and the combustion gas allows reducing that the exhaust gas temperature to below 300° C., even with lean gases, so that a combustion efficiency of over 80% can be achieved. At the same time, excessive air preheating, which can lead to thermal nitrogen oxide formation, is avoided.

This makes it possible to increase the efficiency of the recuperative burner 1 without increasing the heat exchanger surface area, as shown below by way example for a 50 KW burner with a flat tube heat exchanger for lean gas, hydrogen or ammonia with a characteristic value of k×A=50 W/K (A=recuperator surface area, k=heat transfer coefficient) at with an exhaust gas inlet temperature of 1000° C.

| | | Lean gas | Hydrogen | Ammonia |
|---|---|---|---|---|
| Calorific value of the combustion gas | kWh/m3 | 1.5 | 3.0 | 4.0 |
| 1) recuperator without combustion | | | | |
| gas preheating | | | | |
| Heat capacity flows air/exhaust gas | — | 0.58 | 0.78 | 0.7 |
| Air preheating | ° C. | 850 | 790 | 790 |
| Exhaust gas temperature | ° C. | 510 | 385 | 450 |
| Combustion efficiency | — | 0.70 | 0.82 | 0.75 |
| 2) recuperator with combustion | | | | |
| gas preheating | | | | |
| Heat capacity flows air/exhaust gas | — | 1.05 | 1.06 | 0.95 |
| Air preheating | ° C. | 650 | 680 | 670 |
| Exhaust gas temperature | ° C. | 320 | 350 | 360 |
| Combustion efficiency | — | 0.82 | 0.85 | 0.79 |
| Efficiency increase from 2) to 1) | % | 14 | 4 | 5 |

In one embodiment, the number of flat tubes 33 is evenly distributed over the three segments 321, 322, 323. Depending on the combustion gas, a different distribution is provided in other embodiments.

The invention claimed is:

1. A recuperator for a recuperative burner, having a hot side and a cold side, having a housing which is closed in the circumferential direction and which surrounds an exhaust gas duct through which an exhaust gas can flow in the longitudinal direction, and having a plurality of heat exchanger tubes arranged in the exhaust gas duct, wherein a first connection chamber with a first supply connection for combustion air and a second connection chamber with a second supply connection for a combustion gas are provided on the cold side of the exhaust gas duct, wherein the exhaust gas duct is subdivided at least into a first segment fluidically connected to the first connection chamber and a second segment fluidically connected to the second connection chamber, in each of which a part of the heat exchanger tubes is arranged and through which the exhaust gas can flow in parallel, such that a ratio of the heat capacity flow of the cold side to the heat capacity flow of the hot side is between 0.9 and 1.1.

2. The recuperator according to claim 1, wherein the exhaust gas duct is subdivided into three segments, wherein three gas streams, in particular a primary air, a secondary air and the combustion gas, can flow through the heat exchanger tubes arranged in the segments in parallel.

3. The recuperator according to claim 2, wherein the three segments have the same flow cross-sections.

4. The recuperator according to claim 1, wherein filling elements are provided between the segments in order to reduce a flow cross-section, in particular the filling elements (34) being designed as perforated plates.

5. The recuperator according to claim 1, wherein the heat exchanger tubes, on the cold side and/or on the hot side, are accommodated in a connecting plate arranged at a distance from the housing, an outlet opening or an inlet opening for the exhaust gas duct, respectively, being formed between the connecting plate and the housing.

6. The recuperator according to claim 1, wherein a catalyst, in particular a catalyst for ammonia splitting, is arranged in the heat exchanger tubes of the second segment.

7. The recuperator according to claim 1, wherein a catalyst, in particular a catalyst, is arranged in the exhaust gas duct, in an exhaust gas pipe and/or downstream of the exhaust gas pipe.

8. The recuperator according to claim 1, wherein a central tube for a starting heater is arranged in the housing, the exhaust gas duct surrounding the central tube.

9. The recuperator according to claim 1, wherein the housing has a circular or polygon-shaped cross-section, the exhaust gas duct being subdivided into coaxially arranged, annular segments.

10. The recuperator according to claim 9, wherein coaxially arranged, annular connection chamber to the segments are provided.

11. The recuperator according to claim 1, wherein the heat exchanger tubes are designed as flat tubes, which in particular are arranged in concentric circles.

12. A recuperative burner comprising a recuperator according to claim 1.

13. The recuperator burner according to claim 12, wherein the heat exchanger tubes of the first segment and of the second segment, on the hot side, open into a combustion chamber which is surrounded by a combustion chamber housing.

14. The recuperator burner according to claim 13, wherein a temperature sensor is provided at an inlet of the combustion chamber and an adjusting device is provided at the first supply connection and/or at the second supply connection, wherein the adjusting device is set up in order to adjust a quantity of the combustion air supplied via the first supply connection in relation to a quantity of the combustion gas supplied via the second supply connection as a function of a temperature at the inlet of the combustion chamber detected by the temperature sensor.

15. The recuperator burner according to claim 13, wherein the exhaust gas duct is subdivided into three segments, wherein the heat exchanger tubes of the third segment, on the hot side, open into an air guide housing surrounding the combustion chamber housing.

16. The recuperator burner according to claim 15, wherein the combustion chamber housing and the air guide housing have outlet nozzles.
